(19) United States
(12) Patent Application Publication
(10) Pub. No.: US 2014/0251854 A1
(43) Pub. Date: Sep. 11, 2014

(54) BOOK COVER INCORPORATING EYEGLASS HOLDER

(71) Applicant: Holy Bauble LLC, Westfield, NJ (US)

(72) Inventor: Tara O'Brien Flanigan, Westfield, NJ (US)

(73) Assignee: Holy Bauble LLC, Westfield, NJ (US)

(21) Appl. No.: 14/198,997

(22) Filed: Mar. 6, 2014

Related U.S. Application Data
(60) Provisional application No. 61/774,944, filed on Mar. 8, 2013.

(51) Int. Cl. B42D 3/12; B42D 3/18

(52) U.S. Cl. CPC B42D 3/12; B42D 3/18
USPC 206/473; 281/31

(57) ABSTRACT

A cover includes a spine, a front panel hingedly connected to the spine, and a back panel hingedly connected to the spine. A web of material interconnects the front panel and the back panel at a spaced distance from the spine so as to define a compartment between the spine and the web of material. The cover is adapted to cover an article that displays text or other images, and the compartment is adapted to store an article that may be used with the covered article.

### CROSS-REFERENCE TO RELATED APPLICATIONS

The present application claims the benefit of the filing date of U.S. Provisional Application No. 61/774,944 filed Mar. 8, 2013, the disclosure of which is hereby incorporated herein by reference.

### BACKGROUND OF THE INVENTION

The present invention is directed to storage devices, and in particular to storage devices associated with items that display text. Specific embodiments of the present invention are directed to storage devices for reading glasses that may be incorporated in covers for books or other items that display text. For items that display text, reading glasses may be desirable or required for the reader to see the text clearly. This may be the case for conventionally printed materials, such as books, as well as for devices that display the text in electronic form, such as laptop computers, tablets, and other electronic devices. A particular need may exist in instances in which the text is very small, for example, when reading the bible. To enable a reader to have reading glasses readily available when needed, it would be desirable for these books and other devices to incorporate a compartment for safely holding the reading glasses.

### BRIEF SUMMARY OF THE INVENTION

A cover includes a spine, a front panel hingedly connected to the spine, a back panel hingedly connected to the spine, and a web interconnecting the front panel and the back panel at a spaced distance from the spine so as to define a compartment between the spine and the web. The compartment may be lined with cloth.

The cover may include a ribbon having a first end fixed to the compartment and a free end remote from the first end. The ribbon may be at least partially formed from cloth. The ribbon may have an intermediate portion between the first end and the free end, the intermediate portion extending through a slot in the spine. A structure may be connected to the second free end of the ribbon and have a thickness larger than a thickness of the slot.

The cover may include a front pocket provided on the front panel. The front pocket confronts the back panel when the front panel confronts the back panel. The cover may include a back pocket provided on the back panel. The back pocket confronts the front pocket when the back panel confronts the front panel.

The cover may be part of a combination also including an item displaying text, such as a book, a laptop computer, or a tablet computer, and reading glasses. The reading glasses may be positioned within the compartment. A front cover of the book may be positioned within the front pocket and another portion of the book may be positioned in the back pocket.

### BRIEF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a perspective view of a cover according to an embodiment of the invention, the cover being assembled on a book;

FIG. 2 is a perspective view showing the interior of the cover;

FIG. 3 is a perspective view showing the interior of the cover partially assembled on a book;

FIG. 4 is a top perspective view of the cover;

FIG. 5 is a partial top perspective view of the cover assembled on a book;

FIG. 6 is a longitudinal cross-section of the cover showing a pair of glasses stored therein;

FIG. 7 is similar to FIG. 6, but shows the pair of glasses being removed from a storage compartment;

FIG. 8 is a top perspective view of the cover assembled on a book, with a pair of glasses stored in the cover; and

FIG. 9 is similar to FIG. 8, but shows the pair of glasses being removed from the storage compartment.

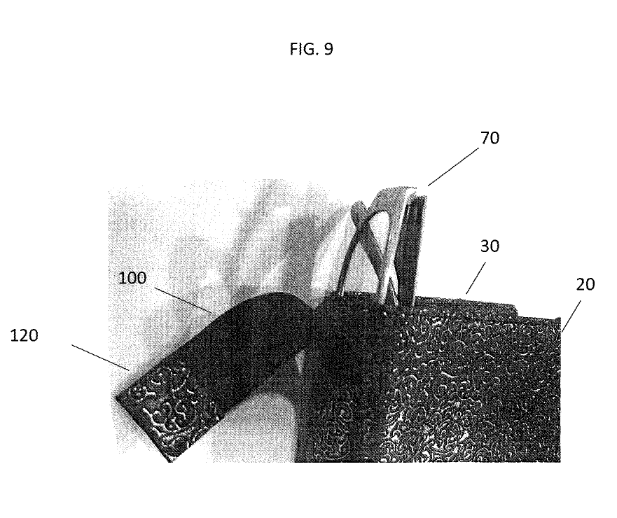

### DETAILED DESCRIPTION

Although the description of the invention contained herein generally relates to a cover for a book, the cover may be used with other items or devices that display text or other images, including, but not limited to, magazines, notebook computers, tablet computers, and electronic reading devices.

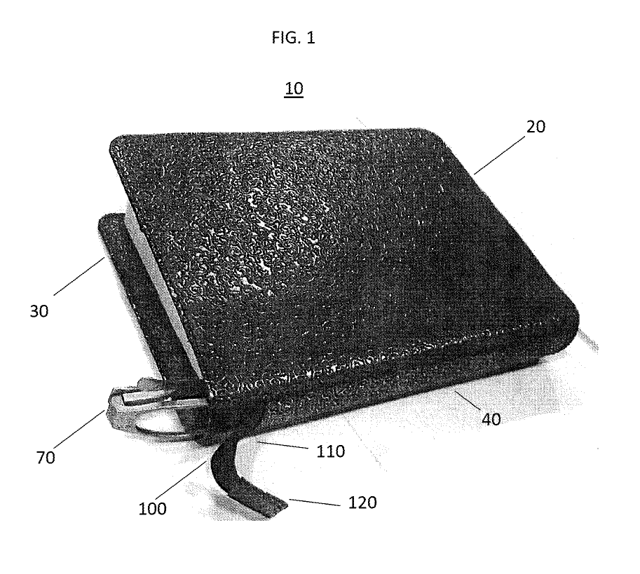

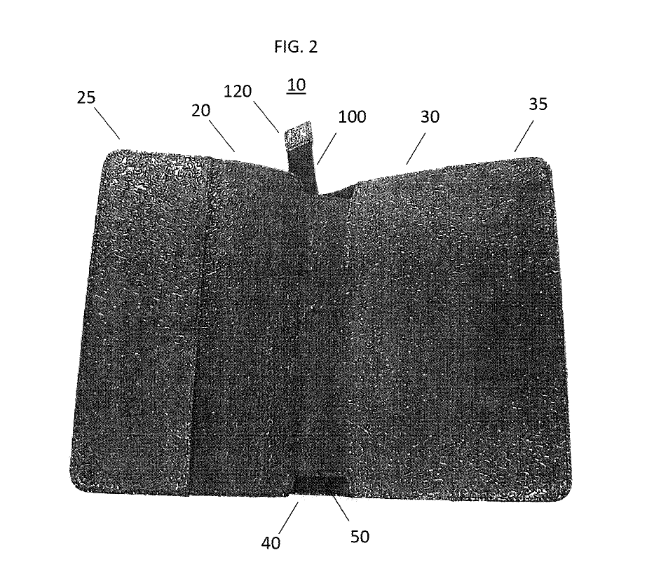

Referring generally to FIGS. 1-2, a cover 10 generally includes a front panel 20, a back panel 30, and a spine 40 connecting the front panel to the back panel. Front and back panels 20, 30 may be hingedly connected to spine 40. The hinged connection may be, for example, a living hinge or an actual hinge. The front panel 20 may include a pocket 25 on its interior surface, and the back panel 30 may include a pocket 35 on its interior surface. Pocket 25 may be a piece of material separate from front panel 20 and attached to the interior surface of the front panel by, for example, stitching, heat welding, gluing, and other known techniques. Alternately, pocket 25 may be formed integrally with front panel 20. For example, front panel 20 may be folded back on itself and fixed in the folded position to form pocket 25. Pocket 25 may have a configuration different from that shown, such as narrow strips of material connected along the top and bottom edges of the interior surface of front panel 20. This configuration is not a true pocket, but rather defines retaining bands along the top and bottom edges of front panel 20, with the panel open at both sides.

Pocket 25 functions to secure an item to cover 10. For example, if cover 10 is being used with a book, a front cover of the book may be inserted into pocket 25. If being used with a laptop, a portion of a keyboard section of the laptop may be slid inside pocket 25. If being used with a tablet, a portion of the tablet may be inserted into pocket 25. The particular configuration of pocket 25 may vary depending on the item to be secured to cover 10. For example, pocket 25 may be sized and shaped to accept a portion of a book cover securely while still allowing for the book to be easily removed from cover 10 by the user. If being used with a laptop, pocket 25 may be sized and shaped to accept a portion of a keyboard section of the laptop without obstructing the use of the keyboard.

Similarly, the pocket 35 of back panel 30 may vary in configuration depending on the item to be used with cover 10. Pocket 35 may be identical to or different than the pocket 25 of front panel 20. For example, if cover 10 is to be used with a book, it may be desirable for pockets 25, 35 to be identical or nearly identical if the front and back covers of the book are identical or nearly identical. If being used with a laptop, for example, the pocket 25 of front panel 20 may be configured to accept a portion of the keyboard section of the laptop, as described above, while the pocket 35 of back panel 30 may be configured to accept a screen portion of the laptop. If accepting the screen portion, the pocket 35 of back panel 30 may be dimensioned differently than the pocket 25 of front panel 20, for example, so that pocket 35 does not cover a portion of the screen intended for viewing. Although FIG. 2 illustrates a cover 10 with two pockets 25, 35, other embodiments of the cover may include a single pocket on either the front panel 20 or the back panel 30. For example, if being used with a tablet, as described above, it may be necessary to have only a single pocket.

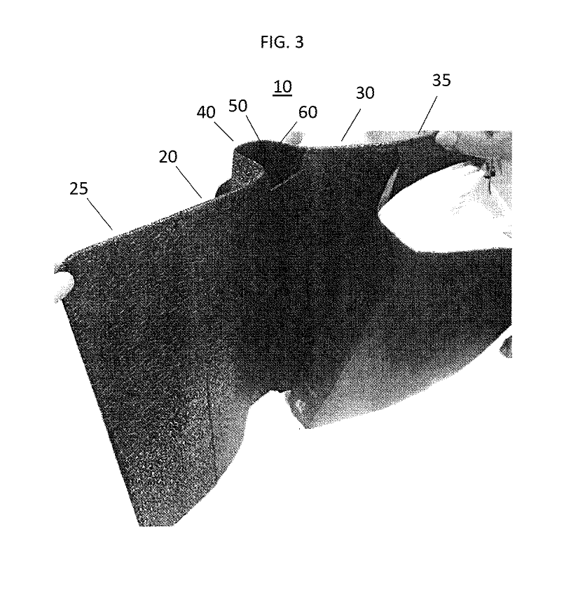

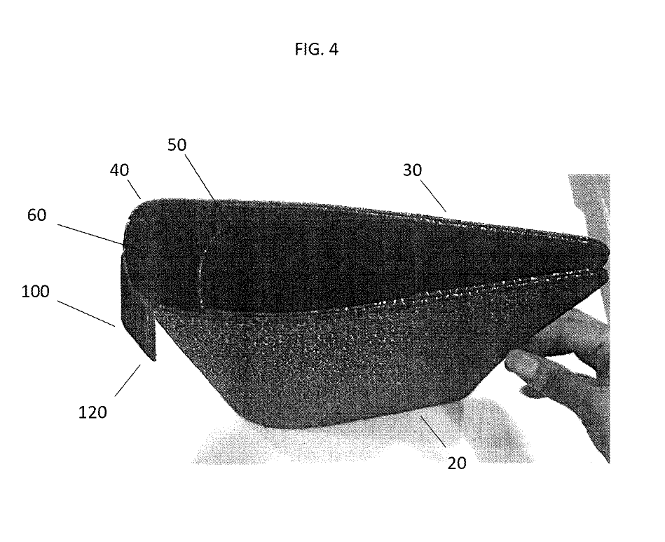

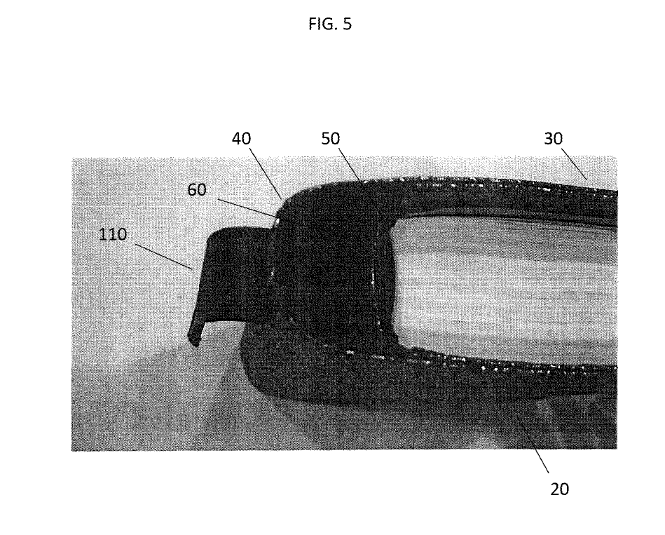

Referring generally to FIGS. 2-5, cover 10 may further include a web 50 connecting front panel 20 to back panel 30 at a spaced distance from spine 40 so as to define a compartment 60 therebetween. The top of compartment 60 may be open to accept an item for storage, as described below, while the bottom of compartment 60 may be closed, for example, by a piece of material connecting the bottom of web 50 to the bottom of spine 40.

Compartment 60 functions as a storage space so that an object that may be frequently used together with the item covered by cover 10 is easily accessible to the user. For example, as shown in the illustrated embodiment, if the item used with cover 10 is a book, compartment 60 may be used to store reading glasses 70. In this embodiment, cover 10 may include particular features useful for the storage of reading glasses 70. For example, the surfaces of spine 40 and web 50 that define compartment 60 may have a soft lining, such as a microfiber cloth lining, to reduce the likelihood of the reading glasses being scratched or otherwise damaged during storage. In another example, spine 40 may be rigid to help protect the contents of compartment 60. This may be accomplished, for example, by forming spine 40 from a rigid material or using a rigid insert inside the spine. Optionally, web 50 may also be formed from a rigid material to further protect the contents of compartment 60. Other items, including but not limited to pens, cell phones, power cords, and styluses, may be stored in compartment 60.

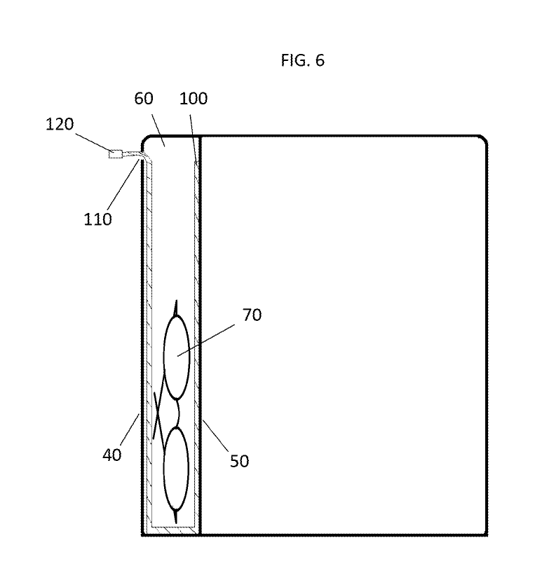

Compartment 60 may include a flexible ribbon 100, as seen in FIG. 6. Ribbon 100 may be formed from a flexible fabric or other material and may serve as the cloth lining in compartment 60, or may be in addition to the cloth lining. One end of ribbon 100 may be attached to web 50 near the open end of compartment 60. Ribbon 100 may be long enough to extend along web 50 to the closed end of compartment 60, and then along spine 40 back to the open end of the compartment. The free end of ribbon 100 may then protrude from compartment 60 through the open end thereof, or through a slot 110 formed in spine 40 near the open end of the compartment. The free end of ribbon 100 may include an enlarged button or other enlarged structure 120 that is sized such that it cannot easily pass through slot 110.

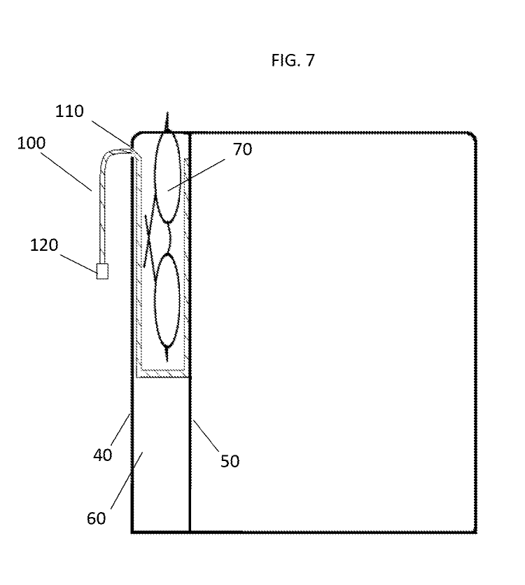

Structure 120 may function as a handle and ensures that the free end of ribbon 100 does not accidentally slip back into compartment 60. When an item such as glasses 70 is stored within compartment 60, the item may not be readily accessible to the user through the open end of the compartment. However, the user may grip structure 120 and pull ribbon 100 out from compartment 60. When pulled, as seen in FIG. 7, the ribbon acts to urge the item stored in compartment 60, such as glasses 70, toward the open end thereof. This urging may make it easier for the user to expel the item from compartment 60.

Additionally, once ribbon 100 protrudes from slot 110, the ribbon may be used to clean the pair of glasses 70 stored within cover 10. If ribbon 100 is formed of a material suitable for cleaning glass, such as a microfiber cloth, the permanent attachment of the ribbon to cover 10 ensures that a cleaning cloth is always available with the cover.

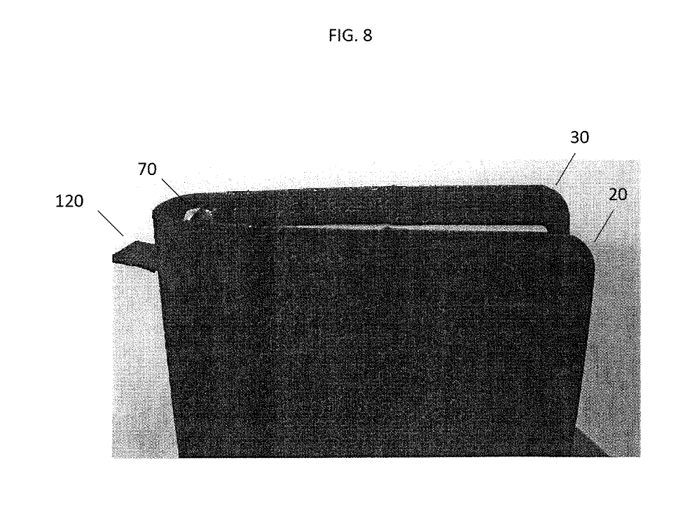

Compartment 60 need not extend the full length of spine 40. For example, the bottom of compartment 60 may be spaced from the bottom of panels 20 and 30. This configuration may be useful if a relatively small item is to be stored in compartment 60, enabling the item to always be accessible near the top of the compartment for easy removal by a user, either with or without use of the ribbon 100. For example, FIG. 8 shows a configuration in which the item being stored in compartment 60 is a pair of glasses 70. As illustrated, even when glasses 70 are fully inserted into compartment 60, the top of the glasses is close to the top of the compartment, making it relatively easy for a user to grasp the glasses to remove them from the compartment. Optionally, this configuration may include a ribbon 100 to help urge glasses 70 out of compartment 60 as described above.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

In the disclosure provided herein, reference is made to particular features of the invention. It is to be understood that the disclosure of the invention in this specification includes all possible combinations of such particular features. For example, where a particular feature is disclosed in the context of a particular aspect, arrangement, or embodiment of the invention, or a particular claim, that feature can also be used, to the extent possible, in combination with and/or in the context of other particular aspects, arrangements, and embodiments of the invention, and in the invention generally.

1. A cover, comprising:
a spine;
a front panel hingedly connected to the spine;
a back panel hingedly connected to the spine; and
a web interconnecting the front panel and the back panel at a spaced distance from the spine so as to define a compartment between the spine and the web.

2. The cover of claim 1, wherein the compartment is lined with cloth.

3. The cover of claim 1, further comprising a ribbon having a first end fixed to the compartment and a free end remote from the first end.

4. The cover of claim 3, wherein the ribbon is at least partially formed from cloth.

5. The cover of claim 3, wherein the spine includes a slot, and the ribbon has an intermediate portion between the first end and the free end, the intermediate portion extending through the slot in the spine.

6. The cover of claim 5, further comprising a structure connected to the free end of the ribbon, the structure having a thickness larger than a thickness of the slot.

7. The cover of claim 1, further comprising a front pocket on the front panel, the front pocket confronting the back panel when the front panel confronts the back panel.

8. The cover of claim 7, further comprising a back pocket on the back panel, the back pocket confronting the front panel when the back panel confronts the front panel.

9. A combination, comprising:
an item displaying text; and
a cover assembled to the item displaying text, the cover including:
a spine;
a front panel hingedly connected to the spine;
a back panel hingedly connected to the spine; and
a web interconnecting the front panel and the back panel at a spaced distance from the spine so as to define a compartment between the spine and the web.

10. The combination of claim 9, further comprising reading glasses positioned within the compartment.

11. The combination of claim 9, further comprising:
a front pocket on the front panel, the front pocket confronting the back panel when the front panel confronts the back panel; and
a back pocket on the back panel, the back pocket confronting the front panel when the back panel confronts the front panel,
wherein a cover of the item displaying text is positioned within the front pocket and another portion of the item displaying text is positioned within the back pocket.

12. The combination of claim 9, wherein the item displaying text is a book.

13. The combination of claim 9, wherein the item displaying text is a laptop computer.

14. The combination of claim 9, wherein the item displaying text is a tablet computer.
